(19) United States
(12) Patent Application Publication
(10) Pub. No.: US 2010/0259712 A1
(43) Pub. Date: Oct. 14, 2010

(54) Display Device with Enhanced Display Quality

(76) Inventors: Youn-Hak Jeong, Cheonan-si (KR); Yeon-Sik Ham, Suwon-si (KR); Yeon-Mun Jeon, Iksan-si (KR); Keun-Chan Oh, Cheonan-si (KR); Kang-Woo Kim, Seoul (KR); Hee-Hwan Lee, Haeundae-gu (KR)

Correspondence Address: F. CHAU & ASSOCIATES, LLC, 130 WOODBURY ROAD, WOODBURY, NY, 11797, US

(21) Appl. No.: 12/755,211

(22) Filed: Apr. 6, 2010

(30) Foreign Application Priority Data
Apr. 9, 2009 (KR) 2009-0030926

(51) Int. Cl. G02F 1/1337

(52) U.S. Cl. 349/128

(57) ABSTRACT

A display device includes a lower polarizing plate, an array substrate, an opposite substrate, a liquid crystal layer and an upper polarizing plate. The array substrate includes a pixel electrode and a lower alignment layer. The pixel electrode has a planar-type electrode portion and a plurality of branch electrode portions extended from the planar-type electrode portion in a first direction, which is formed at about 45 degrees with respect to a first polarization axis. The lower alignment layer is formed on the pixel electrode to be aligned in the first direction. The opposite substrate includes a planar-type common electrode facing the pixel electrode and an upper alignment layer. The upper alignment layer is formed on the common electrode to be aligned in an opposite direction of the first direction.

### CROSS-REFERENCE TO RELATED APPLICATIONS

This application claims priority under 35 U.S.C. §119 to Korean Patent Application No. 10-2009-0030926, filed on Apr. 9, 2009 in the Korean Intellectual Property Office (KIPO), the contents of which are herein incorporated by reference in their entirety.

### BACKGROUND OF THE INVENTION

1. Technical Field

The present invention relates to a display device, and more particularly, the present invention relate to a display device having an enhanced display quality.

2. Discussion of the Related Art

A liquid crystal display (LCD) device is a type of flat panel display device displaying an image using liquid crystal. The LCD device is relatively thin and light and has low power consumption compared to other types of display devices, thereby operating at a relatively low driving voltage. Therefore, the LCD device is widely used in various data processing applications. The LCD device includes display plates in which an electric field generating electrode such as a pixel electrode, a common electrode, etc., is formed. A liquid crystal layer is interposed between the display plates. A voltage is applied to the electric field generating electrode to generate an electric field in the liquid crystal layer. An alignment of the liquid crystal molecules of the liquid crystal layer is determined by the electric field. The polarization of incident light is thereby controlled to display an image.

A vertical alignment (VA) mode LCD device, in which the long axes of liquid crystal molecules are vertically aligned with respect to upper and lower display plates when an electric field is not applied thereto, may have a relatively high contrast ratio. However, the VA mode LCD may have a relatively poor viewing angle and thus may not look satisfactory to a user when viewed from an acute angle.

Moreover, in order to obtain a wide viewing angle, a patterned vertical alignment (PVA) mode LCD device has been developed in which an opening portion is formed through an electric field generating electrode. Moreover, a microslit mode LCD device or a super vertical alignment (SVA) mode LCD device has been developed in which a light alignment process is used instead of a rubbing process for an alignment layer and the slit portion that decreases an aperture ratio has been removed from a common electrode of an upper substrate.

However, transmittance may be decreased by the slit portions, a mask process for forming a microslit portion may be added, and a light alignment process may be complicated. Thus, manufacturing costs of the LCD device may be increased and the yield of the LCD device may be decreased.

### SUMMARY OF THE INVENTION

Exemplary embodiments of the present invention provide a display device manufactured by a simplified manufacturing process and have relatively high transmittance, a high contrast ratio and superior visibility.

According to one aspect of the present invention, a display device includes a lower polarizing plate, an array substrate, an opposite substrate, a liquid crystal layer and an upper polarizing plate. The lower polarizing plate has a first polarization axis. The array substrate is disposed on the lower polarizing plate. The array substrate includes a pixel electrode and a lower alignment layer. The pixel electrode has a planar-type electrode portion and a plurality of branch electrode portions extended from the planar-type electrode portion in a first direction, which is about 45 degrees with respect to the first polarization axis. The lower alignment layer is formed on the pixel electrode and is aligned in the first direction. The opposite substrate includes a planar-type common electrode and an upper alignment layer. The planar-type common electrode faces the pixel electrode. The upper alignment layer is formed on the common electrode and is aligned in a direction opposite to the first direction. The liquid crystal layer is disposed between the array substrate and the opposite substrate and has liquid crystal molecules that are vertically arranged when an electric field is off. The upper polarizing plate disposed on the opposite substrate has a second polarization axis substantially perpendicular to the first polarization axis.

In an exemplary embodiment of the present invention, the lower alignment layer may be rubbed in a first direction and the upper alignment layer may be rubbed in a direction opposite to the first direction. Here, the liquid crystal comprises nematic liquid crystal of which a long axis may be arranged in a direction perpendicular to the direction of the electric field when an electric field is applied to the liquid crystal. In this case, the liquid crystal molecules may be aligned to have a pre-tilt angle of about 80 degrees to about 89.9 degrees.

According to another aspect of the present invention, a display device includes a lower polarizing plate, an array substrate, an opposite substrate, a liquid crystal layer and an upper polarizing plate. The lower polarizing plate has a first polarization axis. The array substrate is disposed on the lower polarizing plate. The array substrate includes a pixel electrode and a lower alignment layer. The pixel electrode has a plurality of branch electrode portions that is extended between a first direction, which is formed at about 45 degrees with respect to the first polarization axis, and the first polarization axis. The lower alignment layer is formed on the pixel electrode. The opposite substrate includes a planar-type common electrode and an upper alignment layer. The planar-type common electrode faces the pixel electrode. The upper alignment layer is formed on the common electrode and is aligned in a second polarization axis direction perpendicular to the first polarization axis. The liquid crystal layer is disposed between the array substrate and the opposite substrate to have liquid crystal molecules vertically arranged when an electric field is off. The upper polarizing plate is disposed on the opposite substrate and has a second polarization axis substantially perpendicular to the first polarization axis.

According to some exemplary embodiments of the present invention, a planar-type electrode portion and a branch electrode portion are disposed at an angle less than about 45 degrees with respect to a polarization axis and are complementally operated at a low gradation and middle and high gradations, and side visibility may be enhanced. In addition, high transmittance and a high contrast ratio may be achieved in a vertical alignment (VA) mode display device.

### BRIEF DESCRIPTION OF THE DRAWINGS

The above and other features of exemplary embodiments of the present invention will become more apparent by describing in detail with reference to the accompanying drawings, in which:

FIG. 1 is a plan view illustrating an array substrate of a display device according to an exemplary embodiment of the present invention;

FIG. 2 is a cross-sectional view taken along a line of the display device having the array substrate as shown in FIG. 1;

FIG. 3 is a plan view illustrating the pixel electrode of FIG. 1;

FIG. 4 is a plan view illustrating a rubbing direction of the opposite substrate of FIG. 2;

FIG. 5 is a schematic diagram illustrating movement of liquid crystal molecules in accordance with a gradation in a second area of the pixel electrode as described below with reference to FIG. 3;

FIG. 6 is a graph showing transmittance in accordance with a position along a second direction in first and second areas of the pixel electrode as described below with reference to FIG. 3;

FIG. 7 is a graph showing a relationship between voltage and transmittance in which the display device as described below with reference to FIGS. 1 to 5 is observed;

FIG. 8 is a plan view illustrating a pixel electrode according to an exemplary embodiment of the present invention;

FIGS. 9 and 10 are plan views respectively illustrating pixel electrodes 670 and 870 of a display device according to an exemplary embodiment of the present invention;

FIG. 11 is a plan view illustrating a pixel electrode of a display device according to an exemplary embodiment of the present invention;

FIG. 12 is a graph showing transmittance in accordance with a position along a first direction in a left area of the pixel electrode when viewed from a plan view of FIG. 11;

FIG. 13 is a graph showing transmittance in accordance with a position along a first direction in a right area of the pixel electrode when viewed from a plan view of FIG. 11;

FIGS. 14 and 15 are plan views illustrating pixel electrodes according to exemplary embodiments of the present invention;

FIG. 16 is a plan view illustrating a pixel electrode of a display device according to an exemplary embodiment of the present invention;

FIG. 17 is a plan view illustrating a pixel electrode of a display device according to an exemplary embodiment of the present invention;

FIG. 18 is a plan view illustrating a pixel electrode of a display device according to an exemplary embodiment of the present invention;

FIG. 19 is a plan view illustrating a pixel electrode of a display device according to an exemplary embodiment of the present invention; and

FIG. 20 is a plan view illustrating a pixel electrode of a display device according to an exemplary embodiment of the present invention.

### DETAILED DESCRIPTION OF THE EXEMPLARY EMBODIMENTS

Exemplary embodiments of the present invention are described more fully hereinafter with reference to the accompanying drawings. The present invention may, however, be embodied in many different forms and should not be construed as limited to the exemplary embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

Hereinafter, exemplary embodiments of the present invention will be explained in detail with reference to the accompanying drawings.

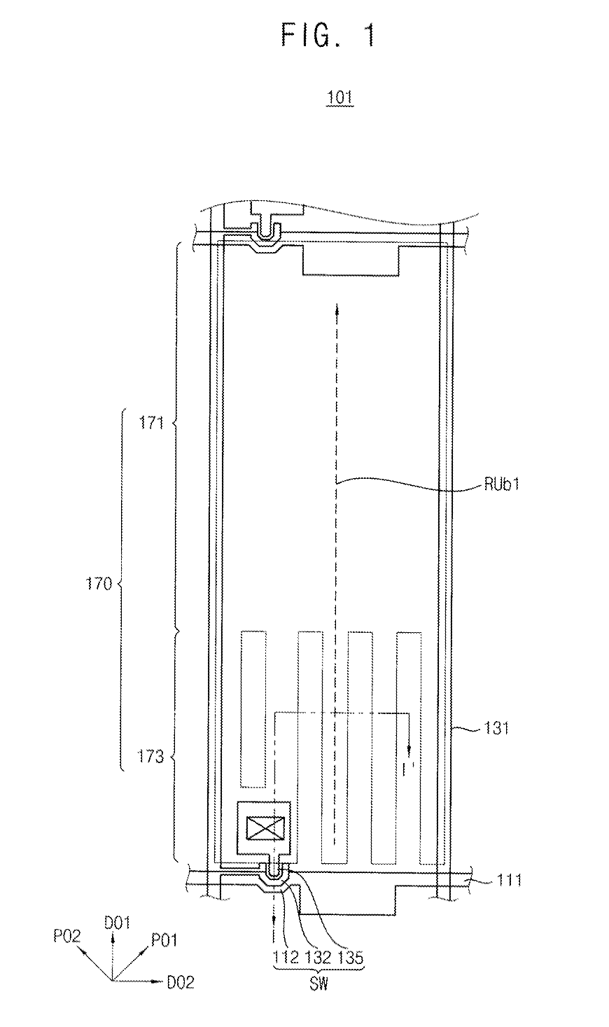

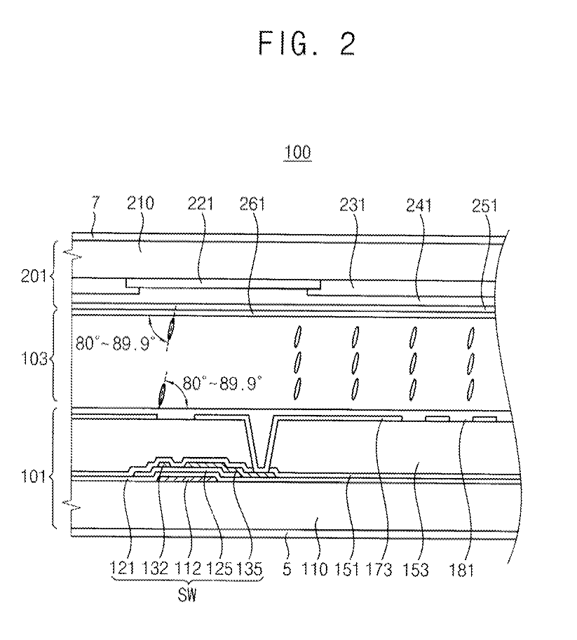

FIG. 1 is a plan view illustrating an array substrate of a display device (FIG. 2, 100) according to an exemplary embodiment of the present invention. FIG. 2 is a cross-sectional view taken along a line I-I′ of the display device 100 having the array substrate as shown in FIG. 1.

Referring to FIGS. 1 and 2, a display device 100 includes a lower polarizing plate 5, an array substrate 101, an opposite substrate 201, a liquid crystal layer 103 and an upper polarizing plate 7.

The array substrate 101 may include a lower substrate 110, a gate line 111, a storage line (not shown), a gate insulation layer 121, a channel layer 125 (which may also be referred to as an active layer), a data line 131, a switching element SW, a passivation film 151, an organic insulation layer 153, a pixel electrode 170 and a lower alignment layer 181. Although the above-described exemplary embodiments discuss the array substrate 101 as an example, the array substrate 101 could be replaced by a substrate where the branch electrode portion 173 is formed through the pixel electrode 170.

A gate metal is deposited on the lower substrate 110 of a glass material or a plastic material and then the gate metal is etched, and the gate lines 111 are formed in parallel and in a horizontal direction (hereinafter, a second direction D02) of a unit pixel area.

The storage line is formed together with the gate line. The gate insulation layer 121 is formed to cover the gate lines 111 and the storage lines.

A semiconductor layer and a source metal layer are sequentially formed on the gate insulation layer 121, and then the semiconductor layer and the source metal layer are etched to form the data lines 131, a source electrode 132, a channel layer 125 and a drain electrode 135 as shown in FIGS. 1 and 2. The data lines 131 is extended in a vertical direction (hereinafter, a first direction) D01 of the unit pixel area perpendicular to the second direction D02 on the gate insulation layer 121.

The gate lines 111 crosses with the data lines 131 to define a substantially rectangular area. The pixel electrode 170 is formed on the rectangular area. Thus, the rectangular area may be defined as the unit pixel area. Alternatively, the shape of the unit pixel area may be formed into various other shapes such as a Z-shape, a V-shape, etc.

The gate electrode 112, the gate insulation layer 121, the channel layer 125, the source electrode 132 and the drain electrode 135 form the switching element SW that is a triple terminal element.

The passivation film 151 is formed to cover the data line 131, and the organic insulation layer 153 is formed on the passivation film 151. A contact hole which partially exposes a portion of the drain electrode 135 is formed through the organic insulation layer 153 and the passivation film 151. The organic insulation layer 153 may be omitted.

The lower polarizing plate 5 may be disposed at a rear surface of the lower substrate 110. The lower polarizing plate 5 may have a first polarization axis P01 which forms an angle of about 45 degrees with respect to the first direction D01.

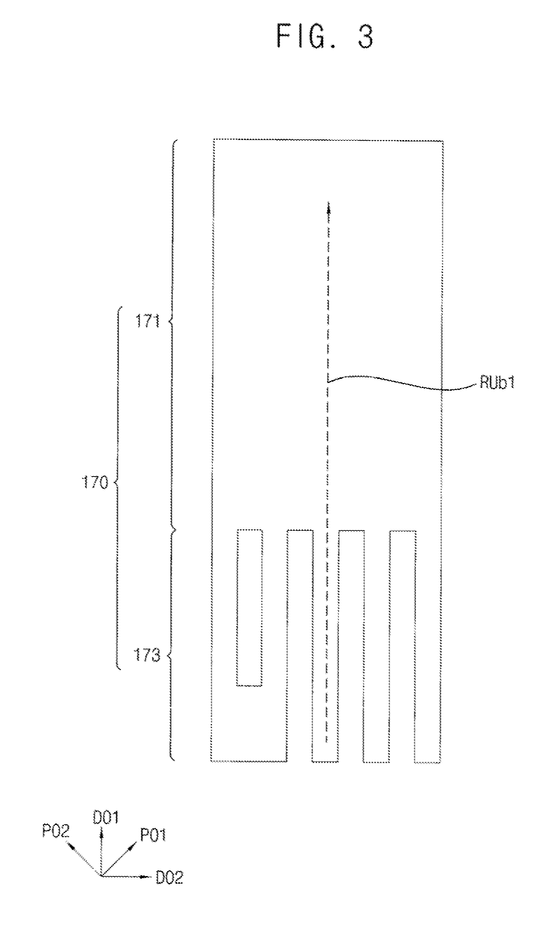

FIG. 3 is a plan view illustrating the pixel electrode 170 of FIG. 1.

Referring to FIGS. 1, 2 and 3, an optically transparent and electrically conductive material layer such as indium tin oxide (ITO) and/or indium zinc oxide (IZO) is deposited on the organic insulation layer 153. The optically transparent and electrically conductive material layer contacts to the drain electrode 135 through the contact hole. The optically transparent and electrically conductive material layer is etched to form the pixel electrode 170.

The pixel electrode 170 includes a planar-type electrode portion 171 and a branch electrode portion 173 that are integrally formed with each other. The planar-type electrode portion 171 has a rectangular shape that is disposed on the unit pixel area in parallel with the first direction D01. A slit or an opening portion is not formed on the planar-type electrode portion 171. An area in which the planar-type electrode portion 171 is formed is defined as a first area.

The branch electrode portion 173 is extended from an edge of the planar-type electrode portion 171 along the first direction D01. Thus, the branch electrode portion 173 is extended in a direction forming an angle of about 45 degrees with respect to the first polarization axis P01. Here, a width of the branch electrode portion 173 may be about 0.5 μm to about 15 μm, and an interval between the branch electrode portions 173 may be about 0.5 μm to about 15 μm. An area on which the branch electrode portion 173 is formed is defined as a second area. The second area is connected to a lower portion of the first area.

Thus, the unit pixel area may be divided into a first area and a second area in which the movements of liquid crystal 104 are different from each other. The movement of the liquid crystal molecules 104 may greatly affect a voltage-transmittance (V-T) graph of the unit pixel area in the second area at a low gradation, and movement of the liquid crystal molecules 104 may greatly affect a V-T graph of the unit pixel area in the first area at middle and high gradations. Thus, the first area is defined as a high area, and the second area is defined as a low area. In one unit pixel area, a ratio of the second area to the first area may be about 10% to about 90%.

A lower alignment layer 181 is formed to cover the pixel electrode 170. For example, a blend of polymer of a polyimide-series is deposited on the pixel electrode 170, and then the blend of polymer is cured and alignment-processed and the lower alignment layer 181 may be formed.

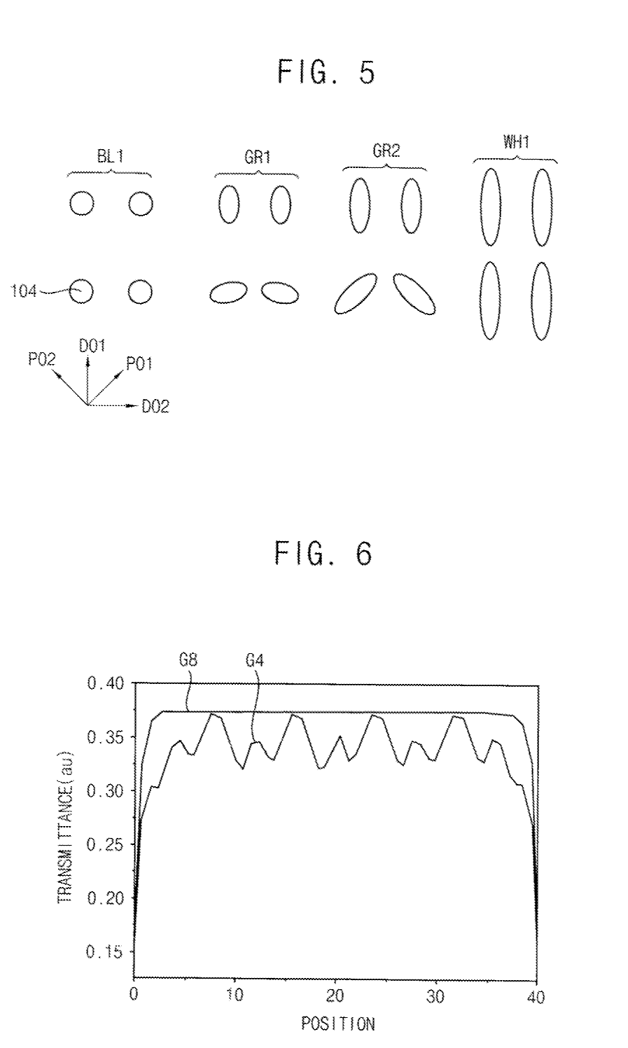

The alignment process is a process which predetermines an inclined direction of liquid crystal (FIG. 5, 104) when an electric field is applied thereto. Here, a rubbing process is used as an example of the alignment process. Alternatively, a rubbing process is not performed and the blend of polymer is optically aligned, and the alignment process may be performed. Here, the lower alignment layer 181 is rubbed (as shown as ‘rub 1’) in the first direction D01. Thus, the first and second areas are rubbed in the first direction D01.

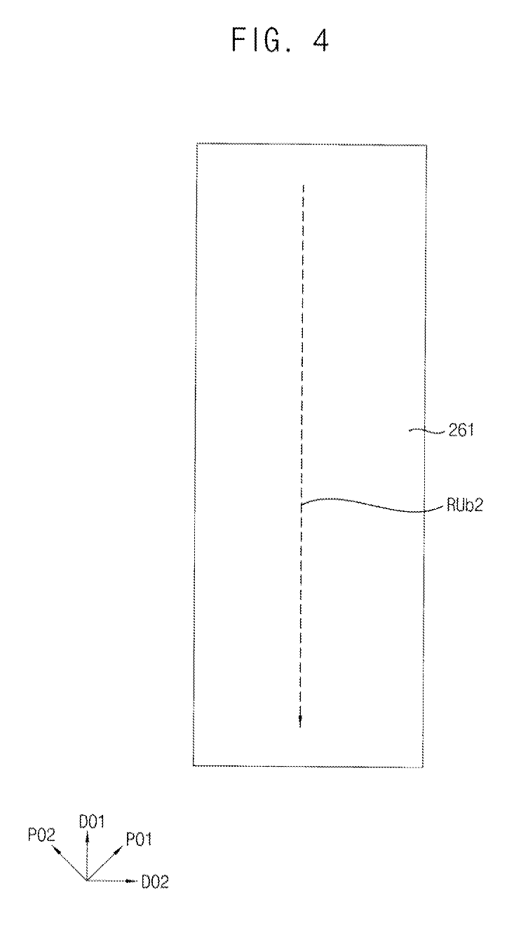

FIG. 4 is a plan view illustrating a rubbing direction of the opposite substrate 201 of FIG. 2.

Referring to FIGS. 2 and 4, the opposite substrate 201 may include an upper substrate 210, a light-blocking pattern 221, a color filter pattern 231, an overcoating layer 241, a common electrode 251 and an upper alignment layer 261.

The light-blocking pattern 221 is formed on the upper substrate 210 in correspondence with the gate line 111, the data line 131, the switching element SW and the storage line. Thus, the color filter pattern 231 is formed in accordance with the unit pixel area where light is not blocked. The color filter pattern 231 may include, for example, a red filter, a green filter and a blue filter. The red filter, the green filter and the blue filter are disposed on each of the unit pixel areas in the order named in the first direction D01.

The overcoating layer 241 covers the color filter pattern 231 and the light-blocking pattern 221. The common electrode 251 is formed on the overcoating layer 241. A material of the common electrode 251 is identical to that of the pixel electrode 170. The common electrode 251 is a planar-type identical to the planar-type electrode portion 171. A slit or an opening portion is not formed through the common electrode 251.

The upper alignment layer 261 is formed on the common electrode 251. A material of the upper alignment layer 261 is identical to that of the lower alignment layer 181. The upper alignment layer 261 is rubbed (as shown as ‘rub2’) in an opposite direction of the first direction D01. Thus, a rubbing direction of the array substrate is different from that of the opposite substrate by about 180 degrees.

The upper polarizing plate 7 may be disposed on the opposite substrate 201. The upper polarizing plate 7 has a second polarization axis P02 perpendicular to the first polarization axis P01. The liquid crystal layer 103 is disposed between the lower alignment layer 181 and the upper alignment layer 261. The liquid crystal layer includes liquid crystal molecules 104. The long axes of the liquid crystal molecules 104 are arranged in a vertical direction substantially perpendicular to the array substrate 101 and the opposite substrate 201 before an electric field is applied between the pixel electrode 170 and the common electrode 251. When an electric field is off due to the rubbing process, the long axes of liquid crystal molecules 104 may be inclined by an angle of about 0.1 degree to about 2 degrees with respect to the vertical direction. That is, the liquid crystal molecules 104 may be aligned to have a pre-tilt angle of about 88 degrees to about 89.9 degrees. Alternatively, the long axes of liquid crystal molecules 104 may be inclined by an angle of about 0.1 degree to about 10 degrees with respect to the vertical direction. That is, the liquid crystal molecules 104 may be aligned to have a pre-tilt angle of about 80 degrees to about 89.9 degrees.

When the lower alignment layer 181 and the upper alignment layer 261 are rubbed as described above and the liquid crystal molecules 104 are aligned in the vertical direction, it is called a “rubbing vertical alignment (RVA) mode.”

When an electric field is applied thereto, the long axes of the liquid crystal molecules 104 are disposed perpendicular to a direction of the electric field. The liquid crystal molecules 104 may have a negative anisotropy of dielectric constant.

FIG. 5 is a schematic diagram explaining movement of liquid crystal molecules 104 in accordance with a gradation in a second area of the pixel electrode 170 as described above with reference to FIG. 3. FIG. 6 is a graph showing transmittance in accordance with a position along a second direction D02 in first and second areas of the pixel electrode as described with reference to FIG. 3.

In FIG. 6, a curve ‘G8’ represents transmittance results in accordance with a position from a left side of the unit pixel area to the second direction D02 on the first area. FIG. 6 shows an observation result where a pixel voltage of about 6 V is applied thereto and then is observed after 300 ms, when a dielectric constant (Δ∈) is about −3.8, an anisotropy refractive index (Δn) is about 0.0822, and a ratio of a width (W) of the branch electrode portion 173 to an interval distance (S) of electrode portions is about 3/4.

A curve ‘G4’ represents transmittance results in accordance with a position from a left side of the unit pixel area to the second direction D02 on the second area. As shown in FIG. 6, the first area has a relatively uniform luminance except edges thereof. The second area has a maximum transmittance at a position of the branch electrode portion 173 and a minimum transmittance between the branch electrode portions 173. As mentioned above, the transmittance of the first area is different from that of the second area, and a difference of transmittances corresponding to the first and second areas may be generated in accordance with a gradation. A V-T graph of the unit pixel area summarizes the results of the influence of the first area and the second area.

A direction of incline for the liquid crystal molecules 104, which is observed in a front of the display device 100, is shown in FIG. 5. The liquid crystal molecules 104 are vertically aligned in a black state BL1 when an electric field is off. In this state of alignment, the liquid crystal molecules 104 may be observed as having a substantially circular shape in the first and second areas.

When the driving signal is applied to the pixel electrode 170 and a full-white state WH1 is realized, the long axes of the liquid crystal molecules 104 are arranged to be perpendicular to an electric field direction in the first and second areas. In the first area, the long axes of the liquid crystal molecules 104 are arranged in parallel with the first direction D01, which is a direction forming an angle to the first polarization axis P01, in accordance with a rubbing direction. In the second area, a fringe field is generated between the branch electrode portions 173 and the fringe field is generated between the branch electrode portions 173 and the common electrode 251. In the full-white state WH1, a fringe field to a second direction D02 perpendicular to the first direction D01 is mainly generated. Thus, in the full-white state WH1, the long axes of the liquid crystal molecules 104 are arranged in the first direction D01 in the second area.

In a first gray state GR1 between the black state BL1 and the full-white state WH1, a vertical electric field between the pixel electrode 170 and the common electrode 251 is low, and a fringe field between the branch electrode portions 173 and the common electrode 251 is high. Thus, in the first area in which the planar-type electrode portion 171 is disposed, the long axes of the liquid crystal molecules 104 are inclined with respect to the array substrate and are inclined in the first direction D01. In the second area, the long axes of the liquid crystal molecules 104 may be affected by an alignment direction of a rubbing and the fringe field. As a result, as shown in FIG. 5, the liquid crystal molecules 104 are disposed to form a first angle that is less than about 45 degrees with respect to the first polarization axis P01. In a second gray state GR01 between the first gray state GR1 and the full-white state WH1, the long axes of the liquid crystal molecules 104 are inclined in the first direction D01 in the first area. In the second area, the long axes of the liquid crystal molecules 104 are inclined to form a second angle with respect to a direction of the first polarization axis P01. The second angle may be greater than the first angle and less than about 45 degrees.

As mentioned above, a third efficiency of the liquid crystal molecules 104 is controlled in accordance with a gradation of the branch electrode portions 173. Here, the third efficiency represents an efficiency in which the long axes of the liquid crystal molecules 104 are arranged in a direction forming an angle about 45 degrees or about 135 degrees to the first polarization axis P01 by an electric field. When the long axes of the liquid crystal molecules 104 are arranged in a direction that forms an angle of about 45 degrees or about 135 degrees to the first polarization axis P01, it can be seen that a maximum luminance is obtained.

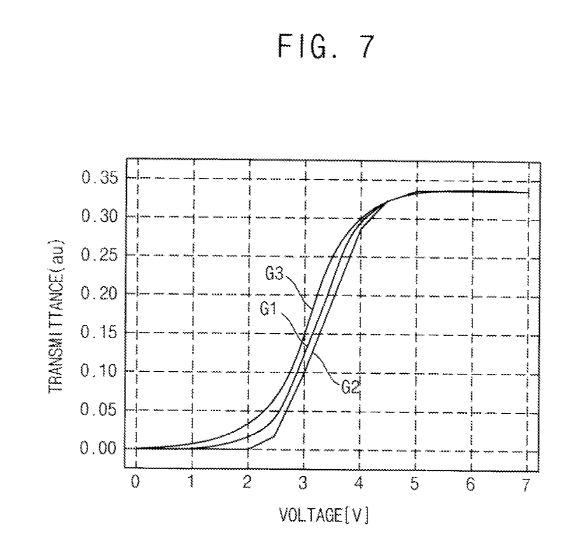

FIG. 7 is a graph showing a relationship between voltage and transmittance in which the display device 100 as described above with reference to FIGS. 1 to 5 is observed.

In FIG. 7, a curve ‘G1’ shows a result of transmittance for an applying voltage when the display device 100 is viewed at a front side thereof. A curve ‘G3’ shows a result of transmittance for an applying voltage when the display device 100 is viewed at an upper-side viewing angle. A curve ‘G2’ shows transmittance for applying voltage when the display device 100 is viewed at a lower-side viewing angle. The upper-side viewing angle represents an opposite direction of an inclined direction of the long axes of the liquid crystal molecules 104, that is, an opposite direction viewing angle of the first direction D01. The lower-side viewing angle represents a direction in which the long axes of the liquid crystal molecules 104 are inclined, that is, the first direction D01.

Referring to FIG. 7, the curve ‘G3’ is spaced apart from the curve ‘G1’ at the upper viewing angle; however, it can be seen that the curve ‘G3’ is close to the curve ‘G1’. Thus, an overly white state of the conventional RVA mode at the upper viewing angle may be prevented.

It can be seen that the curve ‘G2’ is less than the curve ‘G1’ at the lower-side viewing angle; however, the curve ‘G2’ is close to the curve ‘G1’, and a gradation inversion corresponding to the curve ‘G2’ is not existed in comparison with the curve ‘G1’. Thus, a gradation inversion corresponding to a conventional RVA mode may be prevented at a lower-side viewing angle. Therefore, visibility in accordance with a viewing angle at upper and lower sides of the LCD device may be enhanced. In addition, the liquid crystal molecules 104 are symmetrically arranged in the second direction D02 at any gradation. Therefore, a viewing angle of the second direction D02 is enhanced.

Thus, according to exemplary embodiments of the present invention, the visibility of the display device 100 is enhanced. Moreover, the display device 100 is driven in a VA mode, and the display device 100 has a high contrast ratio. In addition, slits of a wide width are not formed through the pixel and common electrodes 170 and 251, and the display device 100 may have high transmittance in comparison with a PVA mode LCD device.

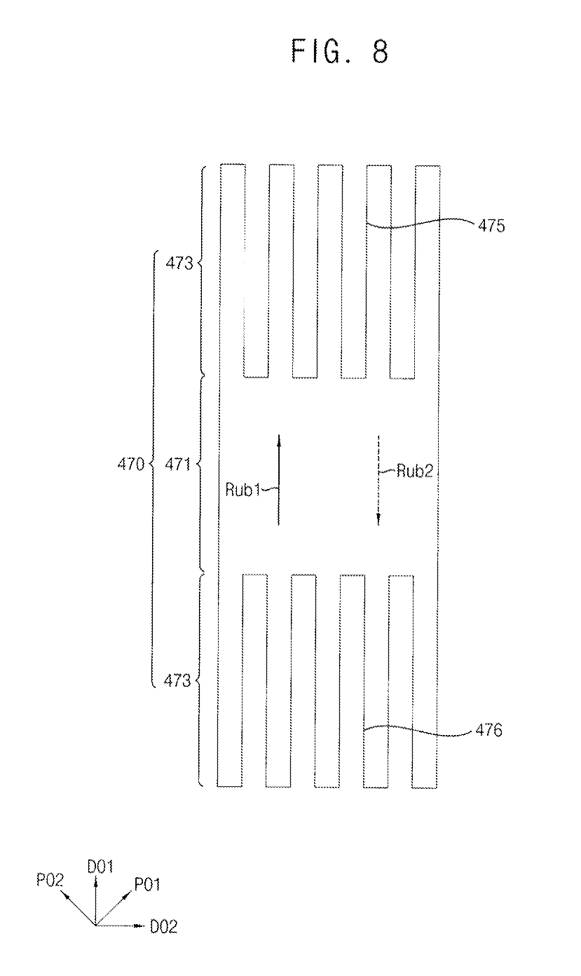

FIG. 8 is a plan view illustrating a variation embodiment of the pixel electrode 170 of FIG. 3.

Referring to FIG. 8, the branch electrode portions 473 may be formed at other edges of the planar-type electrode portion 471. In FIG. 8, the unit pixel area further includes a third area connected to an upper of the first area, and the branch electrode portions 473 may be integrally formed with the planar-type electrode portion 471 on the second area and the third area. The branch electrode portion 473 formed on the second area is defined as a first branch electrode 476, and the branch electrode portion 473 formed on the third area is defined as a second branch electrode 475.

In this case, the first branch electrode 476 and the second branch electrode 475 are symmetric with respect to the first area, and the visibility thereof may be enhanced in comparison with the pixel electrode 170 of FIGS. 1 and 3.

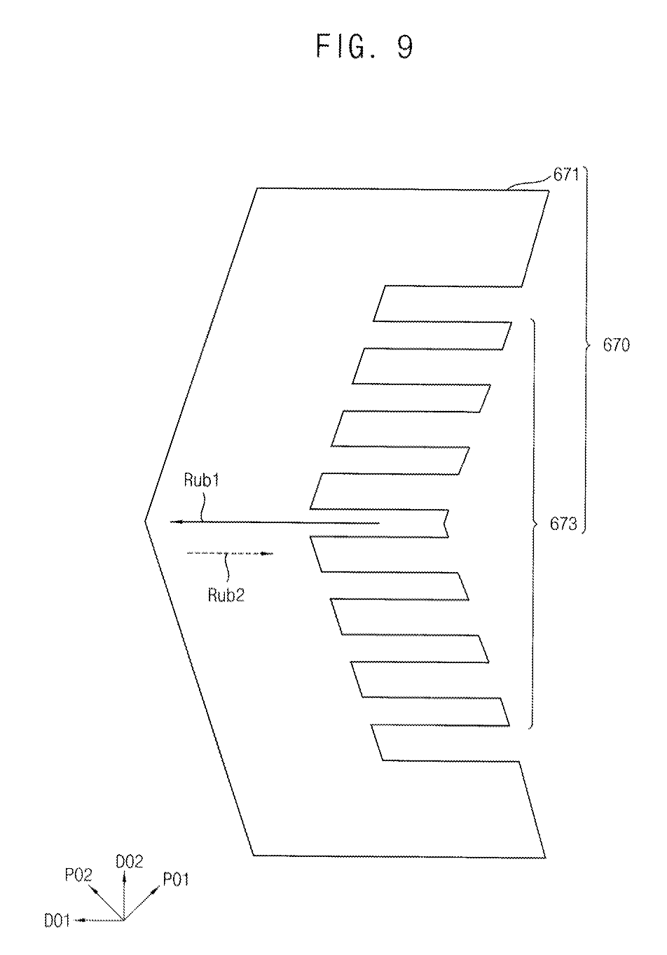

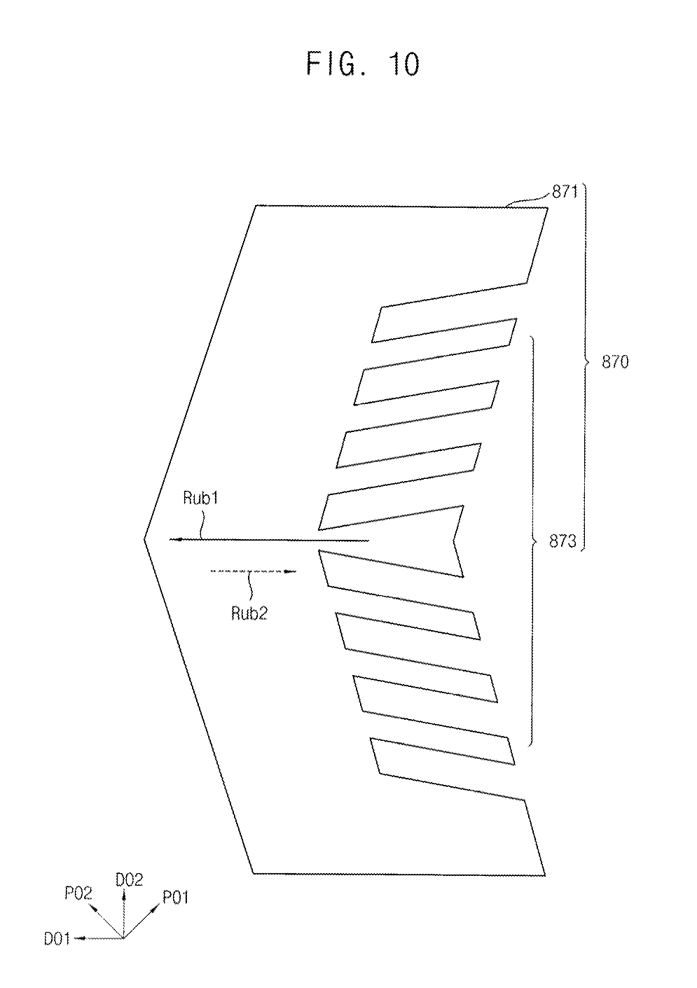

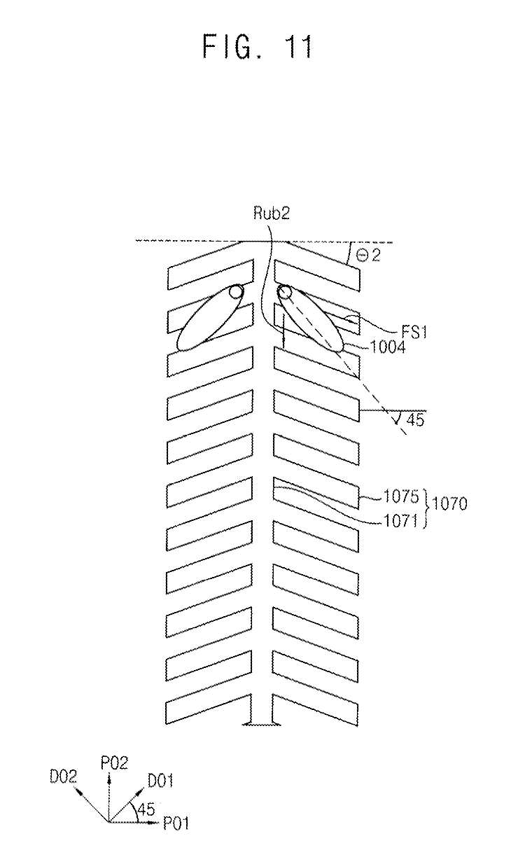

FIGS. 9 and 10 are plan views respectively illustrating pixel electrodes 670 and 870 of a display device according to an exemplary embodiment of the present invention.

Referring to FIGS. 9 and 10, a display device is substantially the same as the display device 100 described above with respect to FIGS. 1 to 7 except that the pixel electrodes 670 and 870 is in a V-shape. Thus, identical reference numerals are used in FIGS. 9 and 10 to refer to components that are the same or like those shown in FIG. 1 to 7.

Here, a unit pixel area has a substantially V-shape. Each of symmetric lines of the pixel electrodes 670 and 870 is disposed in parallel with the first direction D01. Thus, the planar-type electrode portions 671 and 871 also have a substantially V-shape. Branch electrode portions 673 and 873 are respectively extended from edges of the planar-type electrode portions 671 and 871 in an inverted direction of the first direction D01.

In the pixel electrode 670 as shown in FIG. 9, the branch electrode portion 673 is extended from an edge of the planar-type electrode portion 671 in parallel with an inverted direction of the first direction D01. As a result, in accordance with a viewing angle, a V-T graph may be varied similar to a description of FIG. 7.

In the pixel electrode 870 as shown in FIG. 10, the branch electrode portion 873 is extended from an edge of the planar-type electrode portion 871 in an opposite direction of the first direction D01. In FIG. 10, the branch electrode portion 873 and the first direction D01 form an acute angle that is less than about 45 degrees. As a result, in accordance with a viewing angle, a V-T graph may be varied similar to a description of FIG. 7, and a viewing angle may be further increased.

According to exemplary embodiments of the present invention, for example, those discussed above with respect to FIGS. 9 and 10, outer lines of the pixel electrodes 670 and 870 are not perpendicular to the first and second polarization axes P01 and P2, respectively, to form an angle of about 45 degrees. Therefore, the generation of textures may be decreased in comparison with the exemplary embodiments discussed above with respect to FIGS. 1 and 2.

FIG. 11 is a plan view illustrating a pixel electrode 1070 of a display device according to an exemplary embodiment of the present invention.

Referring to FIG. 11, a display device is substantially the same as the display device 100 of FIGS. 1 to 7 except that the pixel electrode 1070 does not have a planar-type electrode portion, the lower alignment layer 181 is not rubbed and an angle between the polarization axis and the branch electrode portion 1075 is varied. Thus, identical reference numerals are used in FIG. 11 to refer to components that are the same or like those shown in FIGS. 1 to 7.

Here, the pixel electrode includes a supporting electrode portion 1071 and a branch electrode portion 1075. The supporting electrode portion 1071 divides a unit pixel area into two areas, with each area disposed in a second polarization axis P02. Each of the branch electrode portions 1075 is extended from the supporting electrode portion 1071, respectively. The unit pixel area is divided into a left area and a right area by the supporting electrode portion 1071.

In the left area, the branch electrode portion 1075 and a first polarization axis P01 form an angle of about 20 degrees to about 30 degrees in a negative direction. In the right area, the branch electrode portion 1075 and the first polarization axis P01 form an angle of about 20 degrees to about 30 degrees in a positive direction. In this case, the negative direction may represent a counterclockwise direction when viewed from a plan view, and the positive direction may represent a clockwise direction when viewed from a plan view.

Here, a rubbing process is not performed at the lower alignment layer 181; however, a rubbing process is performed at the upper alignment layer along the second polarization axis P02. Thus, the long axes of the liquid crystal molecules 1004 may be affected by a rubbing direction of the upper alignment layer and the branch electrode portion 1075, and an alignment direction of the liquid crystal molecules 1004 may be determined. Therefore, when the electric field is applied to the pixel electrode the liquid crystal molecules 1004 may be directed to an angle between an extending direction of the branch electrode portion 1075 and the rubbing direction Rub2 when viewed on a plan view.

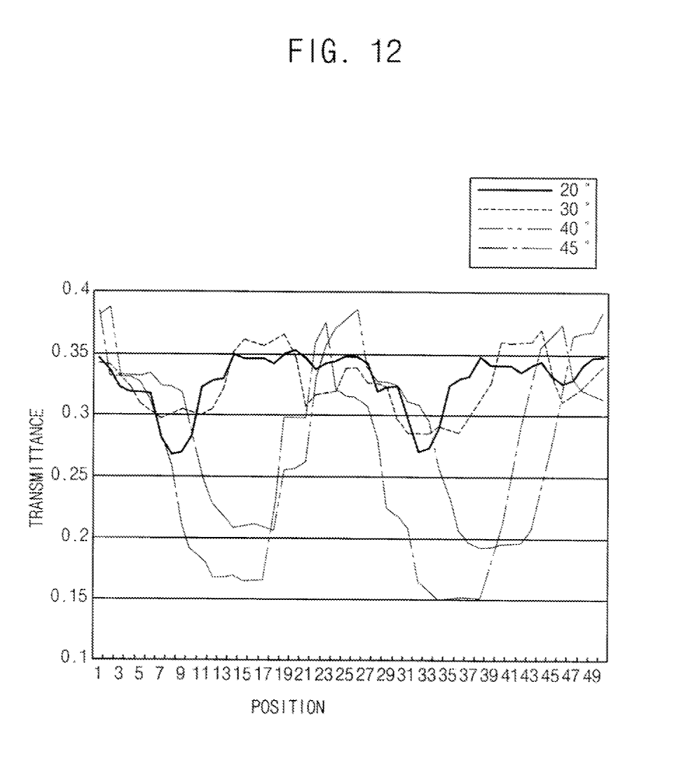

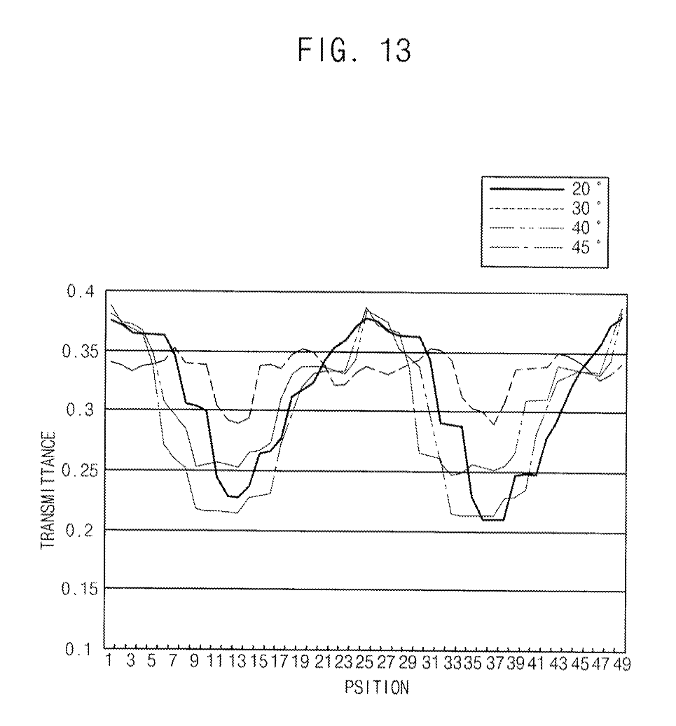

FIG. 12 is a graph showing transmittance in accordance with a position along a first direction D01 in a left area of the pixel electrode 1070 when viewed from a plan view of FIG. 11. FIG. 13 is a graph showing transmittance in accordance with a position along a first direction D01 in a right area of the pixel electrode 1070 when viewed from a plan view of FIG. 11.

In FIGS. 12 and 13, the starting point corresponds to the supporting electrode portion 1071, a horizontal axis represents a distance from the supporting electrode portion 1071 to a left side or a right side, and a vertical axis represents transmittance. Position-transmittance (P-T) graphs are shown in FIGS. 12 and 13, which show parameters that are angles between the branch electrode portion 1075 and the first polarization axis P01.

Referring to FIGS. 12 and 13, when an angle forming the branch electrode portion 1075 and the first polarization axis is about 20 degrees to about 30 degrees, it can be seen that transmittance is high.

Here, the branch electrode portion 1075 forms an angle that is less than about 45 degrees with respect to the first polarization axis P01. Thus, the long axes of the liquid crystal molecules 1004 may be affected by forces aligning liquid crystal molecules in a rubbing direction of the upper alignment layer, that is the second polarization axis P02 direction and an extending direction of the branch electrode portion 1075. As a result, the long axes of the liquid crystal molecules 1004 are arranged in a direction of about 45 degrees with respect to the first polarization axis P01 in a full-white state WH1.

In a black state BL1, the long axes of the liquid crystal molecules 1004 are vertically aligned.

In a gray state between the black state BL1 and the full-white state WH1, the long axes of the liquid crystal molecules 1004 are disposed between the first polarization axis and a first direction D01 forming an angle of about 45 degrees to the first polarization axis P01. Thus, a V-T graph of the display device has a pattern that is substantially similar to the graph as described with reference to FIG. 7. Therefore, an extremely white state may be prevented in an upper-side viewing angle at a low gradation of the display device, and a gradation inversion corresponding to a lower-side viewing angle may be removed. Accordingly, the display device may have enhanced visibility, high transmittance and high contrast ratio.

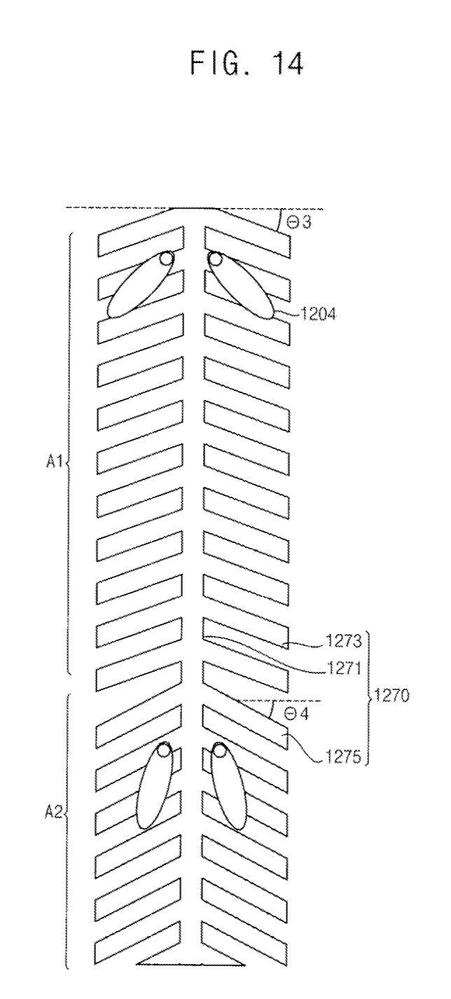

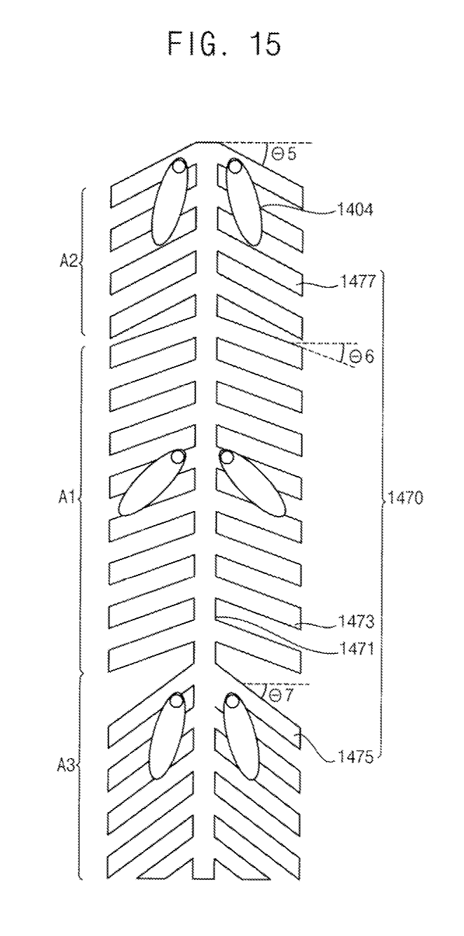

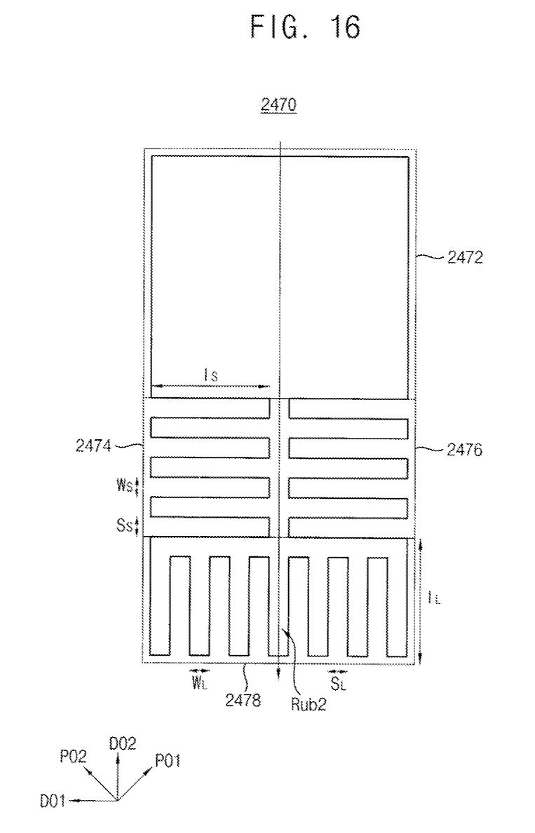

FIGS. 14 and 15 are plan views illustrating various configurations of the pixel electrode 1070 of FIG. 11.

In FIG. 14, a unit pixel area is divided into a first area A1 and a second area A2 that are serially arranged in the second polarization axis P02. The pixel electrode 1270 includes a supporting electrode portion 1271 and two branch electrode portions 1273 and 1275. In the first area A1, the branch electrode portion 1273 and a first polarization axis P01 form an angle of about 45 degrees. In the second area A2, the branch electrode portion 1275 and the first polarization axis P01 form an angle of about 20 degrees to about 45 degrees.

In FIG. 15, a unit pixel area is divided into a first area A1, a second area A2, and a third area A3 that are serially arranged in the second polarization axis P02. The pixel electrode 1470 includes a supporting electrode portion 1471 and three branch electrode portions 1473, 1475, and 1477. In the first area A1, the branch electrode portion 1473 and a first polarization axis P01 form an angle of about 45 degrees. In the second area A2 and the third area A3, the branch electrode portions 1477 and 1475 and the first polarization axis P01 form an angle of about 20 degrees to about 30 degrees.

An angle between the long axes of the liquid crystal molecules 1204 and 1404 and the first polarization axis P01 is varied in accordance with a gradation on the first area, and the long axes of the liquid crystal molecules 1204 and 1404 and the first polarization axis P01 form an angle of about 45 degrees in a full-white state WH1, and a maximum luminance may be obtained.

An angle between the long axes of the liquid crystal molecules 1204 and 1404 and the first polarization axis P01 are varied in accordance with a gradation on the second area, and the long axes of the liquid crystal molecules 1204 and 1404 and the first polarization axis P01 form an angle of no more than about 45 degrees in a full-white state WH1.

Similar results to the V-T graph as described with reference to FIG. 7 may be obtained by movement of liquid crystal molecules 1204 and 1404 on the first area. In the second area, a V-T graph corresponding to the display device of the present embodiment is further compensated at a low gradation from movement of the liquid crystal molecules 1204 and 1404, and a result which is close to the curve ‘G1’ as shown in FIG. 7 may be obtained.

FIG. 16 is a plan view illustrating a pixel electrode of a display device according to an exemplary embodiment of the present invention.

Referring to FIG. 16, the pixel electrode 2470 has a rectangular shape and includes a planar-type electrode portion 2472, a first branch electrode portion 2474, a second branch electrode portion 2476 and a third branch electrode portion 2478. The pixel electrode 2470 may be divided into an upper area and a lower area, when viewed on a plan view. The lower area is divided into a first lower area and a second lower area, when viewed on a plan view. The first lower area is divided into a left-lower area and a right-lower area, when viewed on a plan view.

The planar-type electrode portion 2472 is disposed on the upper area of the pixel electrode 2470. A slit or an opening portion is not formed through the planar-type electrode portion 2472. An area in which the planar-type electrode portion 2472 is formed is defined as a first domain area. According to an exemplary embodiment of the present invention, a rubbing direction Rub2 is opposite to a second direction D02. Thus, the first domain area forms a lower domain by a rubbing process.

The first branch electrode portion 2474 is disposed at the left-lower area of the pixel electrode 2470. A plurality of slits or a plurality of opening portions is formed through the first branch electrode portion 2474 along a first direction D01. The first branch electrode portion 2474 is extended in a direction forming an angle of about 45 degrees with respect to the first polarization axis P01. In the first branch electrode portion 2474, a length Is of the slit is about 34.75 μM, a width Ws of the slit is about 3 μm, and an interval Ss between the slits is about 5 μm. An area on which the first branch electrode portion 2474 is formed is defined as a second domain area. According to an exemplary embodiment of the present invention, the rubbing direction Rub2 is opposite to the second direction D02. Thus, a fringe field is formed by the slits, a storage common electrode line STL is disposed below the pixel electrode 2470, and the second domain area may form a right domain.

The second branch electrode portion 2476 is disposed at the right-lower area of the pixel area 2470. A plurality of slits or a plurality of opening portions is formed through the second branch electrode portion 2476 along an opposite direction of the first direction D01. The second branch electrode portion 2476 is extended in a direction forming an angle of about 45 degrees with respect to the first polarization axis P01. In the second branch electrode portion 2476, a length Is of the slit is about 34.75 μm, a width Ws of the slit is about 3 μm, and an interval Ss between the slits is about 5 μm. An area on which the second branch electrode portion 2476 is formed is defined as a third domain area. According to an exemplary embodiment of the present invention, the rubbing direction Rub2 is opposite to the second direction D02. Thus, a fringe field is formed by the slits, a storage common electrode line STL is disposed below the pixel electrode 2470, and the third domain area may form a left domain.

The third branch electrode portion 2478 is disposed at the first lower area of the pixel area 2470. A plurality of slits or a plurality of opening portions is formed through the third branch electrode portion 2478 along an opposite direction of the first direction D01. The third branch electrode portion 2478 is extended in a direction forming an angle of about 45 degrees with respect to the first polarization axis P01. In the third branch electrode portion 2478, a length I_{L} of the slit is about 14 μm, a width W_{L} of the slit is about 3 μm, and an interval S_{L} between the slits is about 3 μm. An area on which the third branch electrode portion 2478 is formed is defined as a fourth domain area. According to an exemplary embodiment of the present invention, the rubbing direction Rub2 is opposite to the second direction D02. Thus, a fringe field is formed by the slits, the storage common electrode line STL is disposed below the pixel electrode 2470, and the fourth domain area may form an upper domain.

According to an exemplary embodiment of the present invention, a lower alignment layer (not shown) may be formed to cover the pixel electrode 2470. For example, a blend of polymer of a polyimide-series is deposited on the pixel electrode 2470, and then the blend of polymer is cured and alignment-processed and the lower alignment layer may be formed. According to an exemplary embodiment of the present invention, a rubbing direction Rub2 is an opposite direction of the second direction D02 when viewed on a plan view. A common electrode is formed on an opposite substrate (e.g., a color filter substrate) opposite to an array substrate in which the pixel electrode 2470 is formed. The common electrode has a planar shape identical to the planar-type electrode portion 2472. For example, a slit or an opening portion is not formed through the common electrode. A rubbing process is not performed on an opposite substrate opposite to an array substrate having the pixel electrode 2470 according to an exemplary embodiment of the present invention.

As described above, according to an exemplary embodiment of the present invention, a plurality of slits is formed through a portion of the pixel electrode of the array substrate, and then a rubbing process is performed along one direction to divide the pixel electrode into a rubbing vertical alignment area and a slit area. A slit pattern is not formed through the common electrode formed on the opposite substrate opposite to the array substrate, and a rubbing process is also omitted.

For example, since a slit is not formed through the common electrode of the opposite substrate and the rubbing process is omitted, an azimuthal direction of a liquid crystal director is determined by force of the slit the array substrate and rubbing force. Thus, liquid crystal domains may be independently realized.

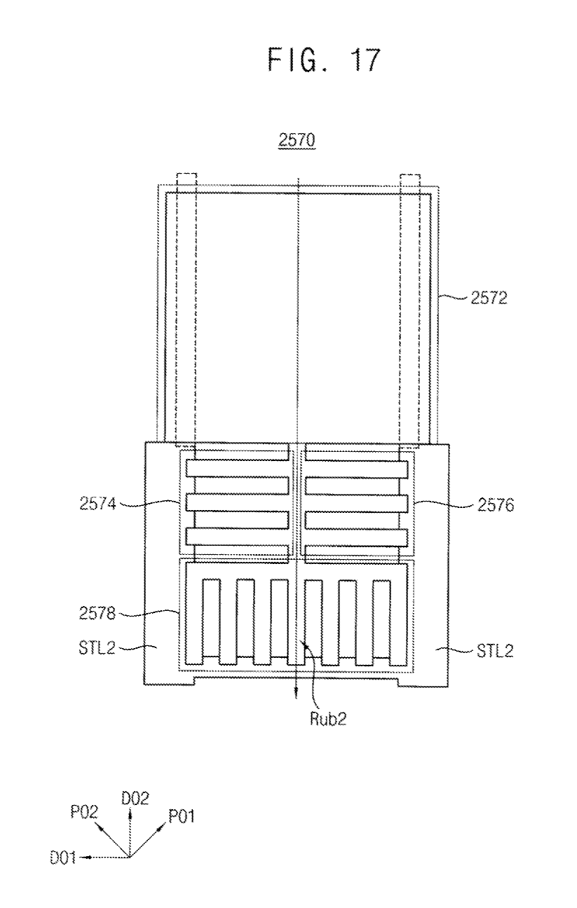

FIG. 17 is a plan view illustrating a pixel electrode of a display device according to an exemplary embodiment of the present invention.

Referring to FIG. 17, the pixel electrode 2570 has a rectangular shape to include a planar-type electrode portion 2572, a first branch electrode portion 2574, a second branch electrode portion 2576 and a third branch electrode portion 2578. In FIG. 17, ‘STL2’ denotes a storage common electrode line. The pixel electrode 2570 having the rectangular shape may be divided into an upper area and a lower area disposed below the upper area, when viewed on a plan view. The lower area is divided into a first lower area and a second lower area disposed below the first lower area, when viewed on a plan view. The first lower area is divided into a left-lower area and a right-lower area, when viewed on a plan view.

The planar-type electrode portion 2572 is disposed on the upper area of the pixel electrode 2570. The storage common electrode line STL2 which overlaps with the planar-type electrode portion 2572 is disposed below the planar-type electrode portion 2572. A slit or an opening portion is not formed through the planar-type electrode portion 2572. An area in which the planar-type electrode portion 2572 is formed is defined as a first domain area. According to an exemplary embodiment of the present invention, a rubbing direction Rub2 is opposite to a second direction D02. Thus, the first domain area forms a lower domain by a rubbing process.

The first branch electrode portion 2574 is disposed at the left-lower area of the pixel electrode 2570. The storage common electrode line STL2 is disposed at an outer side of the first branch electrode portion 2574. The storage common electrode line STL2 may partially overlap with the first branch electrode portion 2574. According to an exemplary embodiment of the present invention, a width of the storage common electrode line STL2 corresponding to the first branch electrode portion 2574 is substantially greater than that of the storage common electrode line STL2 corresponding to the planar-type electrode portion 2572. A plurality of slits or a plurality of opening portions is formed through the first branch electrode portion 2574 in substantially parallel with a second direction D02. The first branch electrode portion 2574 is extended in a direction forming an angle of about 45 degrees with respect to the first polarization axis P01. In the first branch electrode portion 2574, a length Is of the slit is about 34.75 μm, a width Ws of the slit is about 3 μm, and an interval Ss between the slits is about 5 μm. An area on which the first branch electrode portion 2574 is formed is defined as a second domain area. According to an exemplary embodiment of the present invention, the rubbing direction Rub2 is opposite to the second direction D02. Thus, a fringe field is formed by the slits, the storage common electrode line STL2 is disposed below the pixel electrode 2570, and the second domain area may form a right domain.

The second branch electrode portion 2576 is disposed at the right-lower area of the pixel area 2570. The storage common electrode line STL2 is disposed at an outer side of the second branch electrode portion 2576. The storage common electrode line STL2 may partially overlap with the second branch electrode portion 2576. According to an exemplary embodiment of the present invention, a width of the storage common electrode line STL2 corresponding to the second branch electrode portion 2576 is substantially greater than that of the storage common electrode line STL2 corresponding to the planar-type electrode portion 2572. A plurality of slits or a plurality of opening portions is formed through the second branch electrode portion 2576 in substantially parallel with the second direction D02. The second branch electrode portion 2576 is extended in a direction forming an angle of about 45 degrees with respect to the first polarization axis P01. In the second branch electrode portion 2576, a length Is of the slit is about 34.75 μm, a width Ws of the slit is about 3 μm, and an interval Ss between the slits is about 5 μm. An area on which the second branch electrode portion 2576 is formed is defined as a third domain area. According to an exemplary embodiment of the present invention, the rubbing direction Rub2 is opposite to the second direction D02. Thus, a fringe field is formed by the slits, a storage common electrode line STL2 is disposed below the pixel electrode 2570, and the third domain area may form a left domain.

The third branch electrode portion 2578 is disposed at the second lower area of the pixel area 2570. The storage common electrode line STL2 is disposed at an outer side of the third branch electrode portion 2578. The storage common electrode line STL2 may partially overlap with the third branch electrode portion 2578. A plurality of slits or a plurality of opening portions is formed through the third branch electrode portion 2578 in substantially parallel with the first direction D01. The third branch electrode portion 2578 is extended in a direction forming an angle of about 45 degrees with respect to the first polarization axis P01. In the third branch electrode portion 2578, a length I_{L} of the slit is about 14 μm, a width W_{L} of the slit is about 3 μm, and an interval S_{L} between the slits is about 3 μm. An area on which the third branch electrode portion 2578 is formed is defined as a fourth domain area. According to an exemplary embodiment of the present invention, the rubbing direction Rub2 is opposite to the second direction D02. Thus, a fringe field is formed by the slits, the storage common electrode line STL2 is disposed below the pixel electrode 2570, and the fourth domain area may form an upper domain.

As described above, according to an exemplary embodiment of the present invention, the storage common electrode line STL2 is exposed to an external side of the pixel electrode 2570 when viewed from a plan view of the first to third branch electrode portions 2574, 2576 and 2578. Thus, a fringe field may be minimized. Moreover, the storage common electrode line STL2 is overlapped with the pixel electrode 2570 when viewed from a plan view of the planar-type electrode portion 2572. Thus, a fringe field may be minimized.

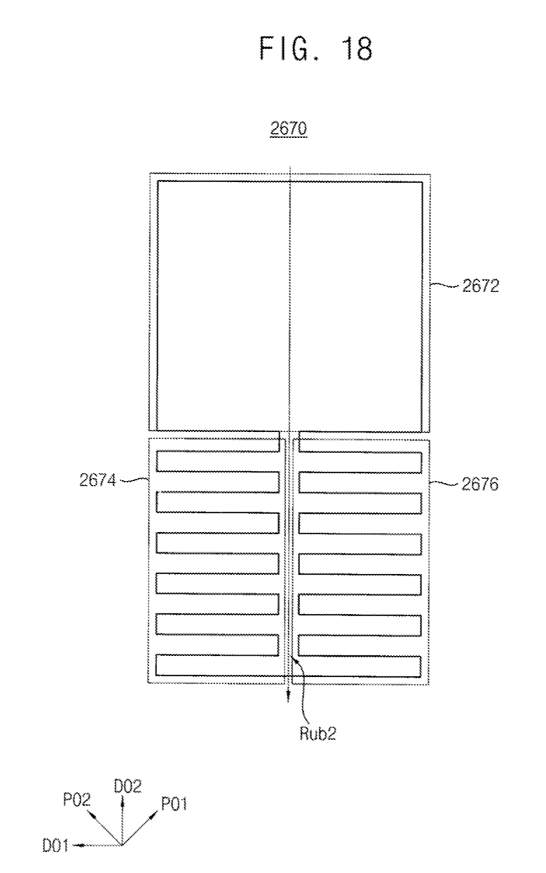

FIG. 18 is a plan view illustrating a pixel electrode of a display device according to an exemplary embodiment of the present invention.

Referring to FIG. 18, the pixel electrode 2670 has a rectangular shape to include a planar-type electrode portion 2672, a first branch electrode portion 2674 and a second branch electrode portion 2676. The pixel electrode 2670 having the rectangular shape may be divided into an upper area and a lower area contacting with the upper area, when viewed on a plan view. The lower area is divided into a left-lower area and a right-lower area, when viewed on a plan view.

The planar-type electrode portion 2672 is disposed on the upper area of the pixel electrode 2670. A slit or an opening portion is not formed through the planar-type electrode portion 2672. An area in which the planar-type electrode portion 2672 is formed is defined as a first domain area. According to an exemplary embodiment of the present invention, a rubbing direction Rub2 is opposite to a second direction D02. Thus, the first domain area forms a lower domain by a rubbing process.

The first branch electrode portion 2674 is disposed at the left-lower area of the pixel electrode 2670. A plurality of slits or a plurality of opening portions is formed through the first branch electrode portion 2674 in substantially parallel with a second direction D02. The first branch electrode portion 2674 is extended in a direction forming an angle of about 45 degrees with respect to the first polarization axis P01. In the first branch electrode portion 2674, a length Is of the slit is about 34.75 μm, a width Ws of the slit is about 3 μm, and an interval Ss between the slits is about 5 μm. An area on which the first branch electrode portion 2674 is formed is defined as a second domain area. According to an exemplary embodiment of the present invention, the rubbing direction Rub2 is opposite to the second direction D02. Thus, a fringe field is formed by the slits, a storage common electrode line STL is disposed below the pixel electrode 2670, and the second domain area may form a right domain.

The second branch electrode portion 2676 is disposed at the right-lower area of the pixel area 2670. A plurality of slits or a plurality of opening portions is formed through the second branch electrode portion 2676 in substantially parallel with a second direction D02. The second branch electrode portion 2676 is extended in a direction forming an angle of about 45 degrees with respect to the first polarization axis P01. In the second branch electrode portion 2676, a length Is of the slit is about 34.75 μm, a width Ws of the slit is about 3 μm, and an interval Ss between the slits is about 5 μm. An area on which the second branch electrode portion 2676 is formed is defined as a third domain area. According to an exemplary embodiment of the present invention, the rubbing direction Rub2 is opposite to the second direction D02. Thus, a fringe field is formed by the slits, a storage common electrode line STL is disposed below the pixel electrode 2670, and the third domain area may form a left domain.

According to an exemplary embodiment of the present invention, a planar-type electrode portion and a branch electrode portion may be formed to define three-domains so as to enhance transmittance. The planar-type electrode portion 2672 defines a first domain, the first branch electrode portion 2674 defines a second domain, and the second branch electrode portion 2676 defines a third domain.

In an exemplary embodiment of the present invention, it is described that a ratio of an area corresponding to the planar-type electrode portion 2672 and an area corresponding to the first and second branch electrode portions 2674 and 2676 is substantially equal to each other. Alternatively, a ratio of an area corresponding to the planar-type electrode portion 2672 and an area corresponding to the first and second branch electrode portions 2674 and 2676 may be different from each other. For example, an area corresponding to the planar-type electrode portion 2672 may be greater than an area corresponding to the first and second branch electrode portions 2674 and 2676. Alternatively, an area corresponding to the planar-type electrode portion 2672 may be smaller than an area corresponding to the first and second branch electrode portions 2674 and 2676. For example, a ratio of an area corresponding to the first and second branch electrode portions 2674 and 2676 may be about 10% to about 70% within the pixel electrode 2670.

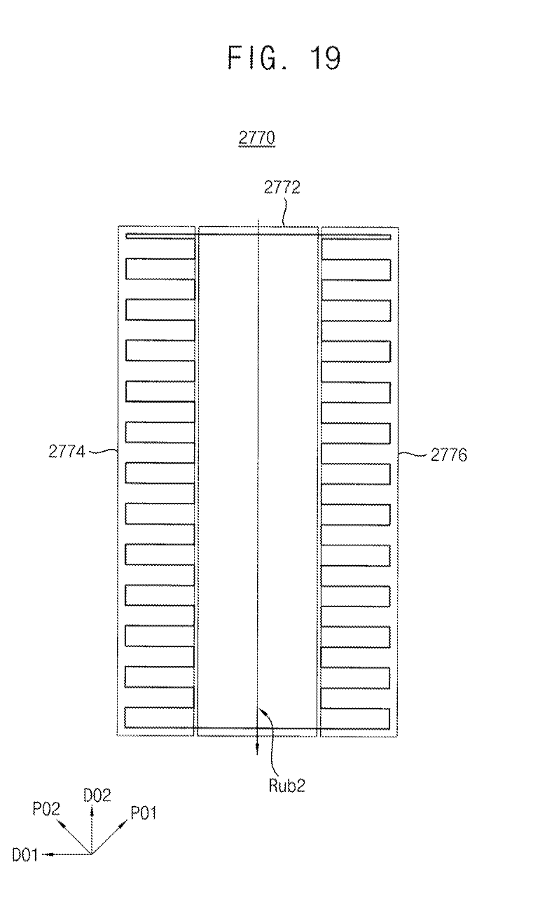

FIG. 19 is a plan view illustrating a pixel electrode of a display device according to an exemplary embodiment of the present invention.

Referring to FIG. 19, the pixel electrode 2770 has a rectangular shape to include a planar-type electrode portion 2772, a first branch electrode portion 2774 and a second branch electrode portion 2776. The pixel electrode 2770 having the rectangular shape may be divided into a middle area, a left area contacting with a left portion of the middle area and a right area contacting with a right portion of the middle area, when viewed on a plan view.

The planar-type electrode portion 2772 is disposed on the middle area of the pixel electrode 2770. A slit or an opening portion is not formed through the planar-type electrode portion 2772. An area in which the planar-type electrode portion 2772 is formed is defined as a first domain area. According to an exemplary embodiment of the present invention, a rubbing direction Rub2 is opposite to a second direction D02. Thus, the first domain area forms a lower domain by a rubbing process.

The first branch electrode portion 2774 is disposed at the left-lower area of the pixel electrode 2770. A plurality of slits or a plurality of opening portions is formed through the first branch electrode portion 2774. The first branch electrode portion 2774 is extended in a direction forming an angle of about 45 degrees with respect to the first polarization axis P01. In the first branch electrode portion 2774, a length Is of the slit is about 34.75 μm, a width Ws of the slit is about 3 μm, and an interval Ss between the slits is about 5 μm. An area on which the first branch electrode portion 2774 is formed is defined as a second domain area. According to an exemplary embodiment of the present invention, the rubbing direction Rub2 is opposite to the second direction D02. Thus, a fringe field is formed by the slits, a storage common electrode line STL is disposed below the pixel electrode 2770, and the second domain area may form a right domain.

The second branch electrode portion 2776 is disposed at the right-lower area of the pixel area 2770. A plurality of slits or a plurality of opening portions is formed through the second branch electrode portion 2776 along a second direction D02. The second branch electrode portion 2776 is extended in a direction forming an angle of about 45 degrees with respect to the first polarization axis P01. In the second branch electrode portion 2776, a length is of the slit is about 34.75 μm, a width Ws of the slit is about 3 μm, and an interval Ss between the slits is about 5 μm. An area on which the second branch electrode portion 2776 is formed is defined as a third domain area. According to an exemplary embodiment of the present invention, the rubbing direction Rub2 is opposite to the second direction D02. Thus, a fringe field is formed by the slits, a storage common electrode line STL is disposed below the pixel electrode 2770, and the third domain area may form a left domain.

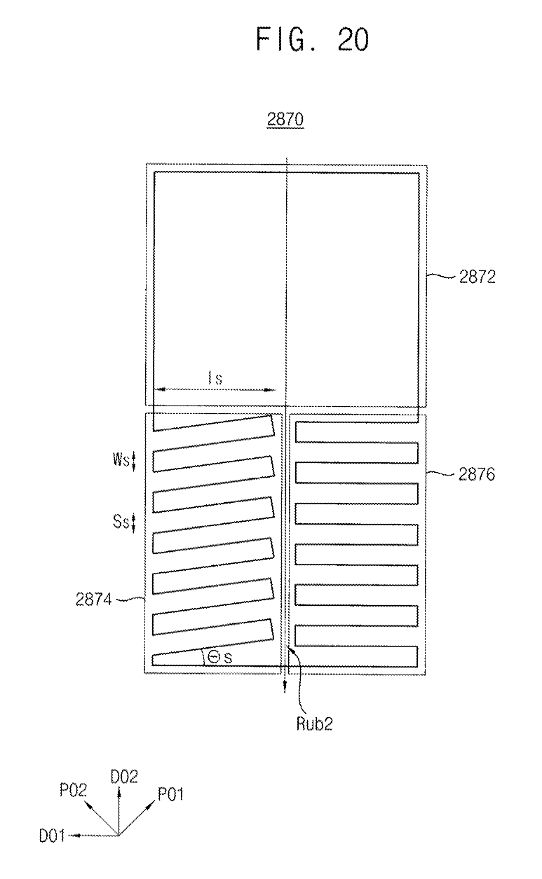

FIG. 20 is a plan view illustrating a pixel electrode of a display device according to an exemplary embodiment of the present invention.

Referring to FIG. 20, the pixel electrode 2870 has a rectangular shape to include a planar-type electrode portion 2872, a first branch electrode portion 2874 and a second branch electrode portion 2876. The pixel electrode 2870 having a rectangular shape may be divided into an upper area and a lower area contacting with the upper area, when viewed on a plan view. The lower area is divided into a left-lower area and a right-lower area contacting with the left-lower area, when viewed on a plan view.

The planar-type electrode portion 2872 is disposed on the upper area of the pixel electrode 2870. A slit or an opening portion is not formed through the planar-type electrode portion 2872. An area in which the planar-type electrode portion 2872 is formed is defined as a first domain area. According to an exemplary embodiment of the present invention, a rubbing direction Rub2 is opposite to a second direction D02. Thus, the first domain area forms a lower domain by a rubbing process.

The first branch electrode portion 2874 is disposed at the left-lower area of the pixel electrode 2870. A plurality of slits or a plurality of opening portions is formed through the first branch electrode portion 2874 in substantially parallel with a crossing direction crossing a second direction D02 by a predetermined angle. The first branch electrode portion 2874 is extended in a direction forming an angle θs of about 10 degrees to about 40 degrees with respect to the first polarization axis P01. In the first branch electrode portion 2874, a length is of the slit is about 34.75 μm, a width Ws of the slit is about 3 μm, and an interval Ss between the slits is about 5 μm. An area on which the first branch electrode portion 2874 is formed is defined as a second domain area. According to an exemplary embodiment of the present invention, the rubbing direction Rub2 is opposite to the second direction D02. Thus, a fringe field is formed by the slits, a storage common electrode line STL is disposed below the pixel electrode 2870, and the second domain area may form a right domain.

The second branch electrode portion 2876 is disposed at the right-lower area of the pixel area 2870. A plurality of slits or a plurality of opening portions is formed through the second branch electrode portion 2876 in substantially parallel with a second direction D02. The second branch electrode portion 2876 is extended in a direction forming an angle of about 45 degrees with respect to the first polarization axis P01. In the second branch electrode portion 2876, a length is of the slit is about 34.75 μm, a width Ws of the slit is about 3 μm, and an interval Ss between the slits is about 5 μm. An area on which the second branch electrode portion 2876 is formed is defined as a third domain area. According to an exemplary embodiment of the present invention, the rubbing direction Rub2 is opposite to the second direction D02. Thus, a fringe field is formed by the slits, a storage common electrode line STL2 is disposed below the pixel electrode 2870, and the third domain area may form a left domain.

Conventionally, a domain is formed in accordance with force by slit and force by a rubbing. Thus, in an exemplary embodiment of the present invention, width and interval of left and right slits, a length of the left and right slits, an angle of the left and right slits, etc., may be varied in accordance with a rubbing force. For example, a slit width and an interval of left and right slit and a lower slit may be formed to have about 2 μm to about 8 μm in accordance with the rubbing force. A length of the lower slit may be about 25 μm. Moreover, a direction of left and right slits may be inclined by about ±20 degrees at a vertical direction of a rubbing direction in accordance with a rubbing force.

Accordingly, the display device of an RVA mode may have enhanced visibility, a high contrast ratio and high transmittance. Thus, exemplary embodiments of the present invention may enhance the display quality of an RVA mode display device in which a manufacturing process may be simple.

The foregoing is illustrative of exemplary embodiments of the present invention and is not to be construed as limiting.

What is claimed is:

1. A display device comprising:
a lower polarizing plate having a first polarization axis;
an array substrate disposed on the lower polarizing plate, the array substrate comprising:
a pixel electrode having a planar-type electrode portion and a plurality of branch electrode portions extended from the planar-type electrode portion in a first direction, the first direction being at an angle between 45 degrees and 90 degrees with respect to the first polarization axis; and
a lower alignment layer formed on the pixel electrode and aligned in the first direction;
an opposite substrate comprising:
a planar-type common electrode facing the pixel electrode; and
an upper alignment layer formed on the common electrode and aligned in an opposite direction of the first direction;
a liquid crystal layer disposed between the array substrate and the opposite substrate having liquid crystal molecules that are vertically arranged when an electric field is off, and
an upper polarizing plate disposed on the opposite substrate having a second polarization axis substantially perpendicular to the first polarization axis.

2. The display device of claim 1, wherein the first direction is at an angle of 45 degrees with respect to the first polarization axis.

3. The display device of claim 1, wherein the lower alignment layer is rubbed in a first rubbing direction and the upper alignment layer is rubbed in an opposite direction of the first rubbing direction.

4. The display device of claim 1, wherein the liquid crystal layer comprises nematic liquid crystal molecules of which a long axis is arranged in a direction perpendicular to a direction of the electric field when the electric field is applied thereto.

5. The display device of claim 4, wherein the liquid crystal molecules is aligned to have a pre-tilt angle of about 80 degrees to about 89.9 degrees.

6. The display device of claim 1, wherein the branch electrode portions are extended from an edge of the planar-type electrode portion in parallel with the first direction.

7. The display device of claim 1, wherein the branch electrode portions include:
a plurality of first branch electrodes extended from an edge in an opposite direction of the first direction; and
a plurality of second branch electrodes extended from the edge in parallel with the first direction.

8. The display device of claim 1, wherein the planar-type electrode portion has a V-shape, and the branch electrode portions are extended from an edge of the planar-type electrode portion along a direction opposite to the first direction.

9. The display device of claim 8, wherein the branch electrode portions are extended from the edge of the planar-type electrode portion in an angle between the first direction and the first polarization axis.

10. The display device of claim 1, wherein the array substrate further comprises:
a signal line delivering a driving signal to the pixel electrode; and
a switching element electrically connecting to the signal line and the pixel electrode.

11. A display device comprising:
a lower polarizing plate having a first polarization axis;
an array substrate disposed on the lower polarizing plate, the array substrate comprising:
a pixel electrode having a plurality of branch electrode portions that is extended in a direction that is between a first direction of 45 degrees with respect to the first polarization axis, and a direction of the first polarization axis; and
a lower alignment layer formed on the pixel electrode; and
an opposite substrate comprising:
a planar-type common electrode facing the pixel electrode; and
an upper alignment layer formed on the common electrode and aligned in a second polarization axis direction perpendicular to the first polarization axis;
a liquid crystal layer disposed between the array substrate and the opposite substrate having liquid crystal molecules that are vertically arranged when an electric field is off; and
an upper polarizing plate disposed on the opposite substrate having the second polarization axis.

12. The display device of claim 10, wherein the lower alignment layer is not rubbed, and
when an electric field is applied to the pixel electrode, the liquid crystal molecules are directed to an angle between an extending direction of the branch electrode portions and the rubbing direction of the upper alignment layer when viewed on a plan view.

13. The display device of claim 10, wherein an extending direction of the branch electrode portions and the first polarization axis form a first angle of no less than 20 degrees and no more than 30 degrees.

14. The display device of claim 13, wherein the liquid crystal layer comprises nematic liquid crystal molecules which are aligned substantially perpendicular to a direction of the electric field when the electric field is applied thereto.

15. The display device of claim 13, wherein the branch electrode portions are symmetric with respect to two sides of the second polarization axis within a unit pixel area wherein the pixel electrode is disposed.

16. The display device of claim 15, wherein the unit pixel area comprises a plurality of sub-areas, and the branch electrode portions and the first polarization axis form different angles within at least two sub-areas of the sub-areas.

17. The display device of claim 16, wherein the branch electrode portions are arranged at the first angle within a first sub-area, of the sub-areas, of the unit pixel area, and are disposed on a second sub-area, of the sub-areas, which contacts a lower portion of the first sub-area along the second polarization axis direction and forms a second angle, with respect to the first polarization axis, that is greater than the first angle.

18. The display device of claim 17, wherein the branch electrode portions are disposed to form a third angle, with respect to the first polarization axis, that is greater than the first angle at a third sub-area, of the sub-areas, which contacts an upper portion of the first sub-area along the second polarization axis direction.

19. A display device comprising:
a lower polarizing plate having a first polarization axis;
an array substrate disposed on the lower polarizing plate, the array substrate comprising:
a pixel electrode having a planar-type electrode portion and a plurality of branch electrode portions extended from the planar-type electrode portion in a first direction, the first direction being at an acute angle with respect to the first polarization axis; and
a lower alignment layer formed on the pixel electrode, aligned in the first direction, and rubbed in a first rubbing direction;
an opposite substrate comprising:
a planar-type common electrode facing the pixel electrode; and
an upper alignment layer formed on the common electrode, aligned in an opposite direction of the first direction, and rubbed in a second rubbing direction opposite to the first rubbing direction;
a liquid crystal layer disposed between the array substrate and the opposite substrate having liquid crystal molecules that are vertically arranged when an electric field is off; and
an upper polarizing plate disposed on the opposite substrate having a second polarization axis substantially perpendicular to the first polarization axis.

20. The display device of claim 19, wherein the planar-type electrode portion has a V-shape, and the branch electrode portions are extended from an edge of the planar-type electrode portion along a direction opposite to the first direction.

21. The display device of claim 20, wherein the branch electrode portions are extended from the edge of the planar-type electrode portion in an angle between the first direction and the first polarization axis.

22. The display device of claim 19, wherein the branch electrode portions is extended from an edge of the planar-type electrode portion in parallel with the first direction.
